(19) United States
(12) Patent Application Publication
(10) Pub. No.: US 2005/0105611 A1
(43) Pub. Date: May 19, 2005

(54) Video compression method

(76) Inventor: Gisle Bjontegaard, Oppegard (NO)

Correspondence Address: CHRISTIAN D. ABEL, ONSAGERS AS, POSTBOKS 6963 ST. OLAVS PLASS, NORWAY, N-0130, NO

(21) Appl. No.: 10/986,758

(22) Filed: Nov. 15, 2004

(30) Foreign Application Priority Data
Nov. 17, 2003 (NO) 2003 5125

(51) Int. Cl. H04N 7/12

(52) U.S. Cl. 375/240.01; 375/240.18; 375/240.12

(57) ABSTRACT

The present invention discloses a method for fractional pixel interpolation in video coding. According to a preferred embodiment of the invention, a symmetric 4-tap filter is used to calculate intermediate ½ pixel values. Further, the ¼ pixel values are calculated by averaging two values of neighboring pixel positions including at least one ½ pixel position in the horizontal and/or vertical direction, e.g. between a ½ pixel position and an integer pixel position The discrete impulse response of the 4-tap filter for calculating k pixel values and the impulse response derived from which for calculating q pixel values, correspond to respective frequency responses which are combined with weights according to the ratio of ½ and ¼ pixel occurrences. The characteristics of the first impulse response, which in the preferred embodiment only have one degree of freedom, are tuned in such a way that the combined frequency response approaches an ideal frequency response being substantially flat close to one at low frequencies, and approaching zero at high frequencies. The present invention is especially useful in motion compensation in connection with inter prediction in video compression similar to the one defined in H.264/AVC.

### FIELD OF THE INVENTION

The invention relates to video compression systems, and in particular to a method in video encoding or decoding for interpolating between integer pixel positions in a video picture.

### BACKGROUND OF THE INVENTION

Transmission of moving pictures in real-time is employed in several applications like e.g. video conferencing, net meetings, TV broadcasting and video telephony.

However, representing moving pictures requires bulk information as digital video typically is described by representing each pixel in a picture with 8 bits (1 Byte). Such uncompressed video data results in large bit volumes, and can not be transferred over conventional communication networks and transmission lines in real time due to limited bandwidth.

Thus, enabling real time video transmission requires a large extent of data compression. Data compression may, however, compromise with picture quality. Therefore, great efforts have been made to develop compression techniques allowing real time transmission of high quality video over bandwidth limited data connections.

In video compression systems, the main goal is to represent the video information with as little capacity as possible. Capacity is defined with bits, either as a constant value or as bits/time unit. In both cases, the main goal is to reduce the number of bits.

The most common video coding method is described in the MPEG* and H.26* standards, all of which using block based prediction from previously encoded and decoded pictures.

The video data undergo four main processes before transmission, namely prediction, transformation, quantization and entropy coding.

The prediction process significantly reduces the amount of bits required for each picture in a video sequence to be transferred. It takes advantage of the similarity of parts of the sequence with other parts of the sequence. Since the predictor part is known to both encoder and decoder, only the difference has to be transferred. This difference typically requires much less capacity for its representation. The prediction is mainly based on picture content from previously reconstructed pictures where the location of the content is defined by motion vectors.

In a typical video sequence, the content of a present block M would be similar to a corresponding block in a previously decoded picture. If no changes have occurred since the previously decoded picture, the content of M would be equal to a block of the same location in the previously decoded picture. In other cases, an object in the picture may have been moved so that the content of M is more equal to a block of a different location in the previously decoded picture. Such movements are represented by motion vectors (V). As an example, a motion vector of (3;4) means that the content of M has moved 3 pixels to the left and 4 pixels upwards since the previously decoded picture.

In H.262, H.263, MPEG1, MPEG2 the same concept is extended so that motion vectors also can take ½ pixel values. A vector component of 5.5 then implies that the motion is midway between 5 and 6 pixels. More specifically the prediction is obtained by taking the average between the pixel representing a motion of 5 and the pixel representing a motion of 6. This is called a 2-tap filter due to the operation on 2 pixels to obtain prediction of a pixel in between. All filter operations can be defined by an impulse response. The operation of averaging 2 pixels can be expressed with an impulse response of (½, ½) Similarly, averaging over 4 pixels implies an impulse response of (¼, ¼, ¼, ¼)

The purpose of the averaging is to define a motion of the picture content with an accuracy of ½ pixel. Further to the impulse response description, the operation could also be interpreted as low pass filtering because the process attenuates high pixel to pixel value variations. As a simple example, assume that the two integer pixels that are to be averaged have the values (a, a), i.e. a minimum variation. Averaging the pixels means using the impulse response (½, ½), resulting in the value ½*a+1/2*a=a. In this case, no information is lost, and the response is defined to be 1. In contrast, (a,−a) implies maximum variation, and exposing these pixel values to the same impulse response results in ½+a−½*a=0, and the corresponding response is 0. From this it could be deduced that the frequency response approaches one towards low frequencies (or pixel value variations) and zero towards high frequencies. This corresponds to the characteristics of a low pass filter. The averaging process removes information content and increasingly more for high frequencies.

FIG. 1 shows the frequency response resulting from averaging of 2 pixels. The curve marked “No filtering” is equal to 1 all the way up to 180 on the x-axis (spatial frequency). The “Two-tap filter” curve falls to 0 for high frequency values.

There is no clearly defined optimal shape of the frequency response curve. However, people skilled in the art would realize the advantage of having the frequency response close to 1 up to a certain frequency. At higher frequencies, the curve should decrease. The reason for the latter is that high frequency content is more difficult to predict, and the prediction at these frequencies (picture content of much texture) does not make sense because the correlation between the prediction and the actual picture content are likely to be small. Thus, it is desirable that this part of the frequency content is attenuated or totally removed. This is illustrated with the “Ideal frequency response” in FIG. 1. The notion of “Ideal frequency response” will be used in the following even if it is not well defined.

Furthermore, there is a relationship between the impulse response and the frequency response. The goal in video compression is to compromise between obtaining a frequency response curve with the characteristics close to the one shown in the “Ideal frequency response” curve of FIG. 1, and to have an impulse response with as few filter taps as possible. The latter is because long filters result in ringing near sharp image content, which may result in subjectively annoying artifacts in the reconstructed picture.

### SUMMARY OF THE INVENTION

The present invention provides a method in video coding or decoding for interpolating between integer pixel positions in a video picture by means of a symmetric tap filter, said method comprising the steps of:
calculating values for ½ pixel positions by the symmetric tap filter having a first discrete impulse response of (a,b,b,a), wherein the taps (a, b) are of the form k/2ⁿ, a+b+b+a=1 and a is within [−0.12, −0.0093, and
calculating values for ¼ pixel positions by averaging between two values of neighboring positions, at least one of which being a ½ pixel position in the horizontal and/or vertical direction.

In an advantageous embodiment, the method further comprises the following steps:
combining a first frequency response associated with the first discrete impulse response and a second frequency response associated with a second discrete impulse response of (a/2,b/2+1/2,b/2,a/2), corresponding to calculating values for ¼ pixel positions, to a third frequency response, and
tuning the first discrete impulse response so that said third frequency response approaches an ideal frequency response having the characteristics of being close to one and substantially flat at low frequencies and decreasing towards zero at high frequencies.

Advantageously, said step of tuning the first impulse response comprises setting the value of a tap (a, b) as a tuning parameter.

Advantageously, said step of combining the first frequency response and the second frequency response includes averaging said first and second frequency response with a weight of ⅕ and ⅘, respectively.

Any one of the above embodiments of the method may advantageously be used in a pixel motion compensation process according to the coding standard H.264/AVC.

### BRIEF DESCRIPTION OF THE DRAWINGS

In order to make the invention more readily understandable, the discussion that follows will refer to the accompanying drawings.

FIG. 1 shows an ideal frequency response in addition to the frequency response of a 2-tap filter and the case of no filtering,

FIG. 2 shows frequency responses of alternative 4-tap filters for ½ pixel positions,

FIG. 3 shows frequency responses of alternative 4-tap filters for ¼ pixel positions,

FIG. 4 shows the-combined frequency responses of those of FIGS. 2 and 3.

### DETAILED DESCRIPTION OF THE PRESENT INVENTION

In the following, the present invention will be discussed by describing a preferred embodiment, and by referring to the accompanying drawing. However, a person skilled in the art will realize other applications and modifications within the scope of the invention as defined in the enclosed independent claim.

A new video compression standard has recently been developed as a joint effort between ITU and ISO/IEC. The formal title's of the common standard in the two standardization bodies are: “TU-T Recommendation H.264” and “ISO/IEC MPEG-4(Part 10) Advanced Video Coding”. In the following this common standard will be referred to as H.264/AVC.

In H.264/AVC coding methods-have improved both in terms of motion resolution and number of pixels for each interpolation. The methods use motion compensated prediction with up to ¼ pixel accuracy. Even ⅛ pixel accuracy is defined, but not included in any profile. The integer- and fractional pixel positions are indicated below (for simplicity, interpolations are only shown between A and E):

| | | | | | | | | |
|---|---|---|---|---|---|---|---|---|
| A″ | E′ | A | b | c | d | E | A′ | E″ |
| | | f | g | h | i | j | | |
| | | k | l | m | n | o | | |
| | | p | q | r | s | t | | |
| | | U | v | w | x | Y | | |

The positions A E U Y indicate integer pixel positions, and A″, E′, A′ and E″ indicates additional integer positions on the A-E line. c k mn o w indicate half pixel positions. The interpolated values in these positions are obtained by using a 6-tap filter with impulse response (1/32, −5/32, 20/32, 20/32, −5/32, 1/32) operating on integer pixel values. As an example, c is then calculated by the following expression:
c=1/32·A″−5/32·E′+20/32·A+20/32·E−5/32·A′+1/32·E′

The filter is operated horizontally or vertically as appropriate. Further, to obtain the value for m, the filter is not operated on integer values, but on already interpolated values in the other direction. The remaining positions in the square depicted above are obtained by averaging respective integer- and half neighbor pixel positions:
b=(A+c)/2, d=(c+E)/2, f=(A+k)/2, g=(c+k)/2, h=(c+m)/2, i=(c+o)/2, j=(E+o)/2
1=(k+m)/2, n=(m+o)/2, p=(U+k)/2, q=(k+w)/2, r=(m+w)/2, s=(w+o)/2, t=(Y+o)/2
v=(U+w)/2, x=(w+Y)/2

All these calculations are performed with rounding towards nearest integer. This means that if A=100 and c=101, b=101 (and not 100 which is as close to the real valued average of 100.5)

One of the problems of the 6-tap filter of prior art is that it does not properly fit into calculation capabilities of standard processors. Hence, more than one calculation step is typically required to obtain one interpolated value, and this is not to prefer due to larger delay and higher processor requirements. A filter of 4 taps or less could on the other hand typically be performed in one calculation cycle. Since we want to calculate ½ pixel positions and prefer a symmetric filter, there are only two alternatives of filters including less than 6 taps, namely 4-tap filter and 2-tap filter.

The inventor of the present invention has found that the subjective experience of picture quality for most humans is better when using 4-tap filters compared to 2-tap filters. Thus, in the following deductive approach, it is assumed that a 4-tap filter is used.

The impulse response of a symmetric 4-tap filter may be expressed as (a,b,b,a). It is moreover assumed that a+b+b+a=1 (or close to 1). The values for a and b are further preferred to be on the form k/2ⁿ where k and n are integers. The reason for this is also mainly to reduce computation complexity because of the binary nature of the processors. An example of an impulse response of a 4-tap filter designed according to the above-mentioned criterions may therefore be: (⅛, ⅜, ⅜, ⅛).

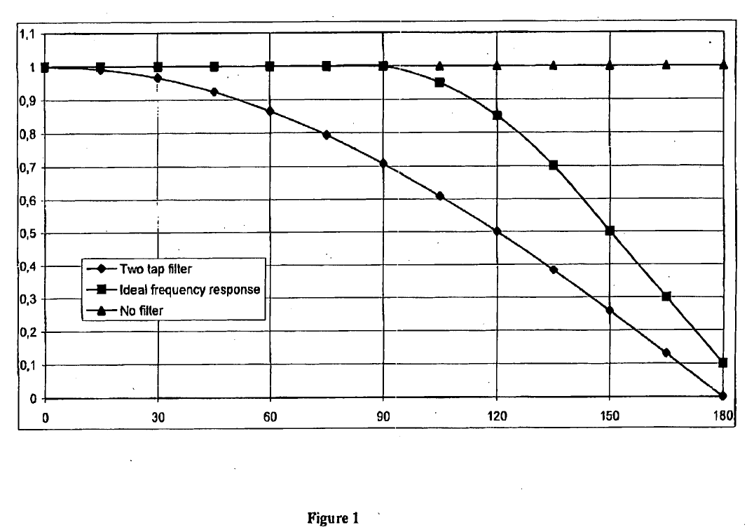

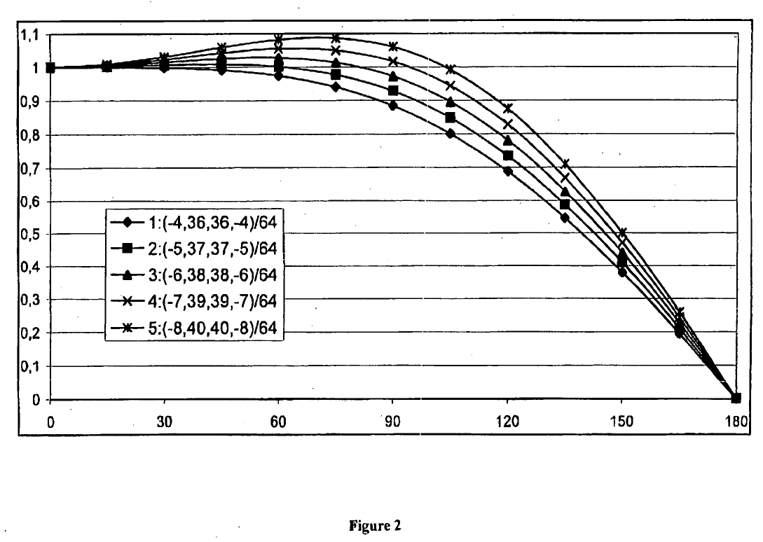

With these restrictions, there is in fact only one dimension of freedom for variation of the filter. This is chosen to be the value of a in the general expression of the 4-tap filter (a,b,b,a). b is derived from a since a+b=½. a could then be used as the tuning parameter for obtaining a filter characteristic as close to an ideal frequency response as the one depicted in FIG. 1, i.e. a frequency response that is maximum flat at low frequencies. FIG. 2 shows the frequency responses of five 4-tap filters to which the impulse responses included therein are corresponding. The frequency responses are basically derived by performing the discrete Fourier transform of the impulse responses. Comparing these frequency responses with the ideal frequency response of FIG. 1, frequency response 1 and 2 seem to be good candidates.

The impulse responses described above are all addressed to calculation of ½ pixel positions. According to the state of the art, averaging between an integer position da a ½ pixel position is performed calculating values of the ¼ pixel positions. Referring to the denotation of the pixel positions depicted in the background section, an example is b=(A+c)/2. In other cases, the averaging is made on two ½ pixel values, erg. when calculating g=(c+k)/2, both c and k are ½ pixel locations but in different directions. The corresponding is true for i, s and q. More generally, an average between two positions is calculated. The filtering effect of this averaging can be considered separately in each direction (horizontal and vertical). For each direction it turns out that one of the two positions is not filtered in the relevant direction and the other position is filtered according to the ½ pixel interpolation. In the example of g=(c+k)/2, c is filtered horizontally due to the ½ pixel interpolation whereas k is not filtered horizontally. Vertically the situation is opposite.

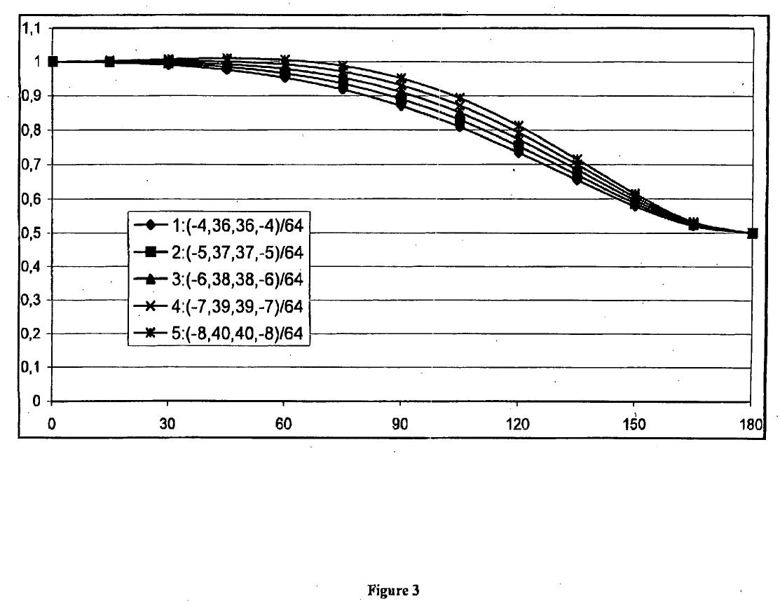

As a result, if the one dimensional impulse response for ½ pixel interpolation is (a,b,b,a), and ¼ pixel values are derived from the average of one k pixel interpolation and one none-½ pixel interpolation (e.g. an integer value) the resulting impulse response for ¼ pixel positions can in some way be represented by (a/2, b/2+1/2, b/2, a/2). The resulting absolute values of the frequency responses are shown in FIG. 3 using the same ; pixel filters as in FIG. 2. Comparing these frequency responses with the ideal frequency response of FIG. 1, frequency responses 4 and 5 seem to be good candidates.

The frequency responses for ½ pixel values are different from the frequency responses for the ¼ pixel values because of different impulse response. However, the purpose of the ideal frequency response, i.e. passing low frequencies through as unaffected as possible and attenuating high frequencies, applies to the picture content as a whole. Therefore, the impulse responses should be tuned in view of obtaining a combined frequency response as close to the ideal frequency response as possible. This does not necessarily result in the same values as when tuning for ½ pixel responses and ¼ pixel responses separately.

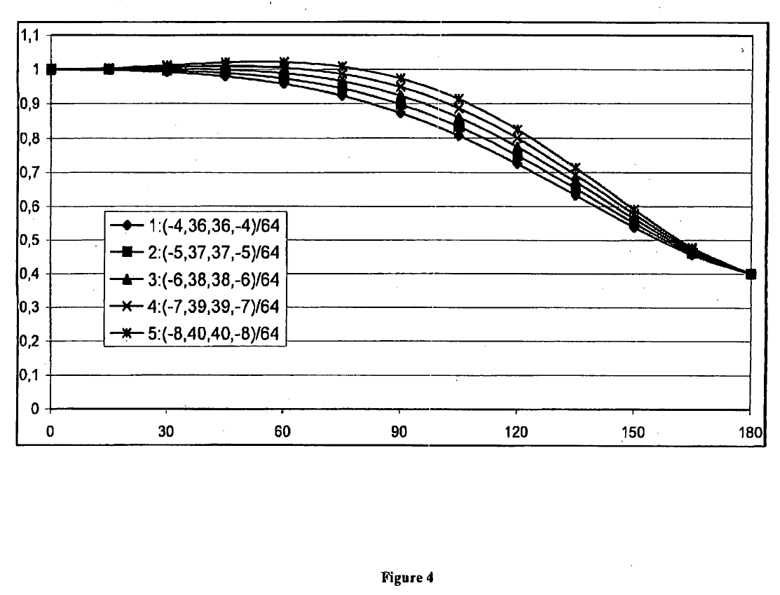

There are on average 4 times as many ¼ pixel positions as ½ pixel positions. When using block based motion compensation all those positions will be used. The statistics of the use is not necessarily evenly distributed, but the combined filtering effect will be a result of a combination of the use of ½ and ¼ pixel position. In FIG. 4 the resulting frequency responses for the 5 filters are shown by averaging with ⅕ weight on the curves in FIG. 2 and ⅘ weight on the curves in FIG. 3. This is only an example on how to calculate a combined frequency response. Other calculations could be used to calculate a combined frequency response taking into account that a mixture of ½ pixel positions and ¼ pixel positions are used in the prediction process.

The curves in this figure are a better base for design of the filter. Comparing these frequency responses with the ideal frequency response of FIG. 1, frequency response curves in the range 3 to 4 seem to result in good combined frequency response. This implies a preferred range of the value of a of −0,12 to −0,09.

1. A method in video coding or decoding for interpolating between integer pixel positions in a video picture by means of a symmetric tap filter, said method comprising the steps of:
calculating values for v pixel positions by the symmetric tap filter having a first discrete impulse response of (a,b,b,a), wherein the taps (a, b) are of the form k/2ⁿ, a+b+b+a=1 and a is within [−0.12, −0.09], and
calculating values for ¼ pixel positions by averaging between two values of neighboring positions, at least one of which being a ½ pixel position in the horizontal and/or vertical direction,

2. A method according to claim 1, further comprising the following steps:
combining a first frequency response associated with the first discrete impulse response and a second frequency response associated with a second discrete impulse response of (a/2,b/2+1/2,b/2,a/2), corresponding to calculating values for ¼ pixel positions, to a third frequency response, and
tuning the first discrete impulse response so that said third frequency response approaches an ideal frequency response having the characteristics of being close to one and substantially flat at low frequencies and decreasing towards zero at high frequencies.

3. A method according to claim 2, wherein said step of tuning the first impulse response comprises setting the value of a tap (a, b) as a tuning parameter.

4. A method according to claim 2 or 3, wherein said step of combining the first frequency response and the second frequency response includes averaging said first and second frequency response with a weight of ⅕ and ⅘, respectively.

5. Method according to one of the claims 1-3, wherein the video picture is encoded according to the coding standard H.264/AVC.

6. Method according to claim 4, wherein the video picture is encoded according to the coding standard H.264/AVC.
